(19) United States
(12) Patent Application Publication
(10) Pub. No.: US 2009/0290061 A1
(43) Pub. Date: Nov. 26, 2009

(54) Camera module

(75) Inventors: Sang Hwan Choi, Suwon-si (KR); Seung Man Oh, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/222,230

(22) Filed: Aug. 5, 2008

(30) Foreign Application Priority Data
May 21, 2008 (KR) 10-2008-0046977

(51) Int. Cl. H04N 5/225

(52) U.S. Cl. 348/340; 348/E05.024

(57) ABSTRACT

Provided is a camera module including a substrate; an image sensor that is mounted on the substrate; and a housing that is coupled to the top surface of the substrate and has a lens assembly integrally provided on the center thereof, the lens assembly having a plurality of lenses stacked therein, and a plurality of support portions which project from the side walls of the housing in the lower side of the lens assembly so as to be contact-supported by the top and side surfaces of the image sensor.

### CROSS-REFERENCE TO RELATED APPLICATIONS

This application claims the benefit of Korean Patent Application No. 10-2008-0046977 filed with the Korea Intellectual Property Office on May 21, 2008, the disclosure of which is incorporated herein by reference.

### BACKGROUND OF THE INVENTION

1. Field of the Invention

The present invention relates to a camera module in which a plurality of support portions formed in a housing are supported by the top and side surfaces of an image sensor mounted on a printed circuit board (PCB) at three or more positions.

2. Description of the Related Art

Recently, camera modules are mounted on IT devices such as mobile terminals, PDAs (Personal Digital Assistant), MP3 players and so on. With the development of technology, the resolution of the camera modules changes from 300,000 pixels (VGA) to several million pixels, and the reduction in size and thickness of the camera modules are being performed depending on mounting targets. Further, the camera module provides various additional functions, such as auto-focusing (AF) and optical zoom.

In such camera modules, image sensor modules are mounted, which are manufactured by a COF (Chip on Film) method, a COB (Chip on Board) method, and a CSP (Chip Scale Package) method. The image sensor module is connected to a main substrate through an electrical connection unit such as a PCB (Printed Circuit Board) or FPCB (Flexible Printed Circuit Board).

Recently, however, as the thickness of IT equipments including mobile terminals is reduced, there is demand for a camera module of which the height is reduced as much as possible, thereby simplifying a manufacturing process and reducing a manufacturing cost.

The camera modules are manufactured in such a manner that CCD (Charge Coupled Device) or CMOS (Complementary Metal Oxide Semiconductor) image sensors are attached on a substrate by a wire bonding method or flip-chip method. Incident light transmitted through the lens is condensed by the image sensor and is stored as data in a memory. The stored data is displayed as an image through a display medium, such as liquid crystal display (LCD) or PC monitor.

Hereinafter, the structures of the camera modules manufactured by the COF and COB methods will be described.

First, the camera module manufactured by the COF method is constructed in such a manner that a housing, a lens group, and a barrel are sequentially coupled. The housing has an image sensor supported by the bottom surface thereof, the image sensor converting image signals received through lenses into electrical signals. The lens group collects image signals of an object into the image sensor. The barrel has the lens group stacked therein.

Further, a flexible printed circuit board (FPCB) is electrically connected to a lower portion of the housing. Chip components (e.g., capacitors and resistors) for driving the image sensor are mounted on the FPCB.

In the camera module 1 constructed in such a manner, an ACF (Anisotropic Conductive Film) is inserted between the FPCB and the image sensor in such a state that a plurality of circuit components are mounted on the FPCB. Then, heat and pressure are applied to electrically attach the FPCB to the image sensor, and an IR filter is attached on the FPCB.

Furthermore, in such a state that the barrel and the housing are provisionally screwed to each other, the assembled FPCB is fixed to the bottom surface of the housing by a separate adhesive.

Meanwhile, after the housing to which the FPCB and the barrel are coupled is fixed by an adhesive, an object (resolution chart) is set at a predetermined distance in front of the barrel so as to perform focus adjustment. The focus adjustment of the camera module, that is, the focus adjustment between the lens group and the image sensor is performed as a vertical transfer amount of the barrel is adjusted by rotating the barrel screwed to the housing.

However, when the barrel screwed to the housing is rotated and vertically transferred so as to adjust the focus of an image formed in the image sensor, the portion of the barrel screwed to the housing may be tilted. In this case, the optical axis may be tilted.

The camera module manufactured by the COB method is constructed in such a manner that a PCB having an image sensor mounted thereon by wire bonding is coupled to a lower portion of a housing formed of plastics, and a lens barrel having a cylindrical body extending downward is coupled to a barrel extending upward from the housing.

In the camera module, the housing and the lens barrel are coupled to each other by coupling a female screw portion formed on the inner circumferential surface of the barrel to a male screw portion formed on the outer circumferential surface of the cylindrical body.

In the camera module assembled in such a manner, while light incident from a specific object passes through a lens, an image is inverted so as to be focused on the surface of the image sensor. At this time, when the focus is optimally adjusted by rotating the lens barrel screwed to the upper end of the housing, an adhesive is injected between the housing and the lens barrel such that the housing and the lens barrel are bonded to each other. Then, the camera module is finalized.

In the camera module having such a structure, after the image sensor and the housing are attached on the PCB, the lens barrel is coupled to the upper end of the housing. Then, as the height of the lens barrel is adjusted with respect to the reference point of the PCB, the focus adjustment is performed.

However, an image on the image sensor may be shifted by a minute shift of the lens or image sensor or an assembling error, and the focus adjustment should be performed on each module. Therefore, the manufacturing process requires a lot of time, thereby degrading productivity.

### SUMMARY OF THE INVENTION

An advantage of the present invention is that it provides a camera module in which a plurality of support portions formed in a housing are supported by the top and side surfaces of an image sensor at three or more positions. Therefore, the image sensor and lenses are prevented from being shifted and rotated, and the distance between the image sensor and the lenses is constantly maintained.

Additional aspects and advantages of the present general inventive concept will be set forth in part in the description which follows and, in part, will be obvious from the description, or may be learned by practice of the general inventive concept.

According to an aspect of the invention, a camera module comprises a substrate; an image sensor that is mounted on the substrate; and a housing that is coupled to the top surface of the substrate and has a lens assembly integrally provided on the center thereof, the lens assembly having a plurality of lenses stacked therein, and a plurality of support portions which project from the side walls of the housing in the lower side of the lens assembly so as to be contact-supported by the top and side surfaces of the image sensor.

The support portions may be contacted-supported by the top surface of the image sensor at three or more positions and contact-supported by the side surfaces of the images sensor at three or more positions.

The support portions may include a first support portion which is contact-supported by a first side surface and the top surface of the image sensor; a second support portion which is spaced at a predetermined distance from the first support portion so as to be contact-supported by the first side surface of the image sensor; a third support portion which is contact-supported by the top surface of the image sensor so as to face the first support portion; and a fourth support portion which is contact-supported by a second side surface and the top surface of the image sensor, the second side surface being adjacent to the first side surface.

The first side surface of the image sensor may have a different length from the second side surface adjacent to the first side surface.

The length of the first side surface may be larger than that of the second side surface.

The support portions may be contact-supported by the outer region of the light receiving portion of the image sensor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view of a camera module according to an embodiment of the invention;

FIG. 2 is a cross-sectional view taken along I-I′ line of FIG. 1;

FIG. 3 is a cross-sectional view taken along II-II′ line of FIG. 1; and

FIG. 4 is a cross-sectional view taken along III-III′ line of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, a camera module according to the present invention will be described in detail with reference to the accompanying drawings.

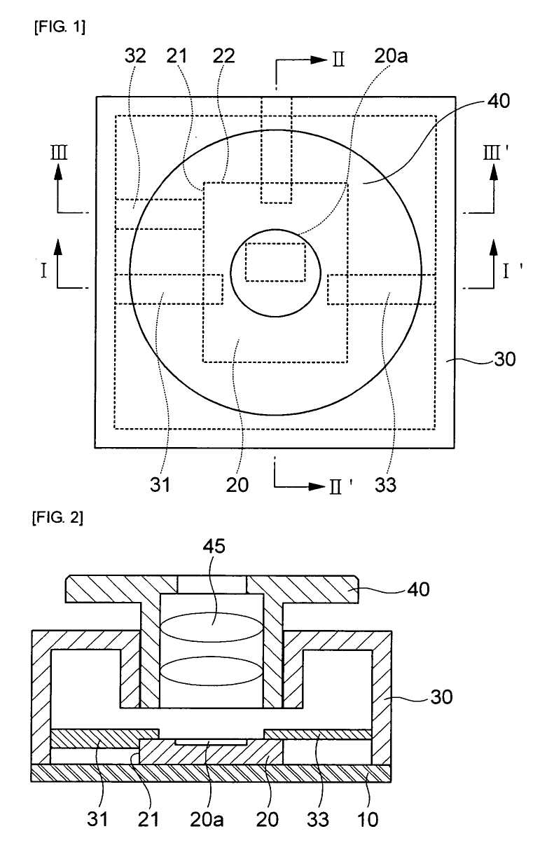

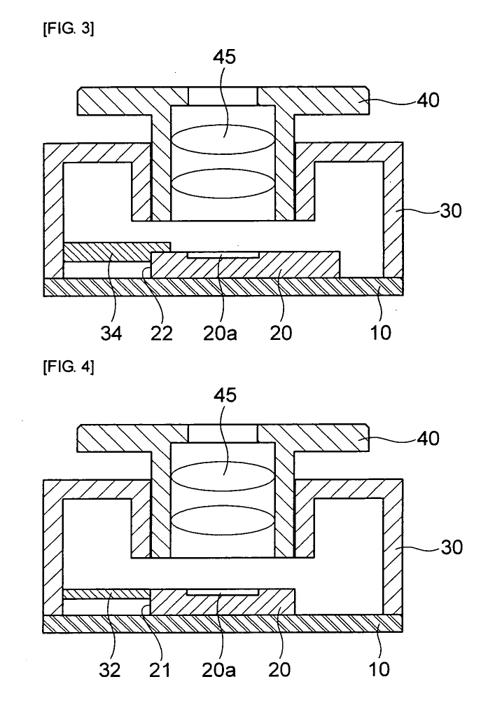

FIG. 1 is a plan view of a camera module according to an embodiment of the invention. FIG. 2 is a cross-sectional view taken along I-I′ line of FIG. 1. FIG. 3 is a cross-sectional view taken along II-II′ line of FIG. 1. FIG. 4 is a cross-sectional view taken along III-III′ line of FIG. 1.

As shown in FIGS. 1 to 4, the camera module according to the embodiment of the invention includes a PCB 10, an image sensor 20 mounted on the PCB 10, and a housing 30 coupled to the top surface of the PCB 10.

The image sensor 20 has a light receiving portion 20a formed on the top surface thereof, the light receiving portion 20a having a predetermined area.

The housing 30 has a lens assembly 40 integrally provided on the center thereof, the lens assembly 40 having a plurality of lenses 45 stacked therein.

In the camera module according to this embodiment, a plurality of support portions 31 to 34 are formed under the lens assembly 40. The support portions 31 to 34 project from the side walls of the housing 30, respectively, so as to be contact-supported by the top and side surfaces of the image sensor 20 at arbitrary positions.

The plurality of support portions 31 to 34 may be formed integrally with the housing 30, when the housing 30 is molded.

In this case, it is preferable that the support portions 31 to 34 are contact-supported by the top and side surfaces of the image sensor 20 at three or more arbitrary positions.

For example, the housing 30 may have a first support portion 31 (refer to FIG. 2) which is contact-supported by a first side surface 21 and the top surface of the image sensor 20 and a second supporting portion 32 (refer to FIG. 4) which is spaced at a predetermined space from the first supporting portion 31 so as to be contact-supported by the first side surface 21 of the image sensor 20.

As shown in FIG. 2, the first supporting portion 31 may be formed to have an L-shaped cross-section such that the end thereof comes in contact with the first side surface and the top surface of the image sensor 20.

In addition, the housing 30 may have a third supporting portion 33 (refer to FIG. 2) which is contact-supported by the top surface of the image sensor 20 so as to face the first support portion 31. Further, the housing 30 may have a fourth supporting portion 34 (refer to FIG. 4) which is contact-supported by a second side surface 22 and the top surface of the image sensor 20, the second side surface 22 being adjacent to the first side surface 21 of the image sensor 20.

Like the first supporting portion 31, the fourth supporting portion 34 may be formed to have an L-shaped cross-section such that the end thereof comes in contact with the second surface 22 and the top surface of the image sensor 20.

Meanwhile, the first side surface 21 of the image sensor 20 may have a different length from the second side surface 22 adjacent to the first side surface 21.

As described above, the first and second support portions 31 and 32, that is, two support portions are contact-supported by the first side surface 21. Therefore, the length of the first side surface 21 may be set to be larger than that of the second side surface 22 by which only one support portion 34 is contact-supported.

As such, the plurality of support portions 31 to 34 formed on the housing 30 can be supported by the top and side surfaces of the image sensor 20 at three or more positions.

That is, the first, third, and fourth support portions 31, 33, and 34 are contact-supported by the top surface of the image sensor 20, and the first, second, and fourth support portions 31, 32, and 34 are contact-supported by the side surfaces of the image sensor 20. Therefore, the position of the housing 30 having the lens assembly 40 integrally provided thereon can be fixed to an accurate position so as not to be shifted, rotated, or tilted with respect to the image sensor 20.

The side walls of the housing 30, on which the plurality of support portions 31 to 34 are formed to project, may be designed in such a manner that the length thereof correspond to a focal distance of the lens 45 which is determined between one lens 45 of the lens assembly 40 and another lens 45 provided under the one lens 45.

Therefore, as the housing 30 having the lens assembly 40 integrally provided thereon is received on the PCB 10 having the image sensor 20 mounted thereon, the distance between the image sensor 20 and the lens 45 is constantly maintained, so that focus adjustment is completed. Therefore, a separate process for focus adjustment is not necessary, which makes it possible to reduce the number of processes.

That is, the support portions 31 to 34 serve to fix the positions of the image sensor 20 and the housing 30 having the lens assembly 40 integrally provided thereon. The number and the positions of the support portions 31 to 34 are not limited specifically.

Preferably, the support portions 31 to 34 are contact-supported by the outer region of the light receiving portion 20a of the image sensor 20 so as not to interfere with a light path through which light is incident on the light receiving portion 20a of the image sensor 20.

According to the camera module of this embodiment, the plurality of support portions 31 to 34, which project from the side walls of the housing 30 so as to be contact-supported by the top and side surfaces of the image sensor 20, can accurately adjust and fix the optical axis of the lenses 45 with respect to the center of the image sensor 20, within a range of assembling tolerance.

Further, as the assembling process and the focus adjusting process for the camera module are simultaneously performed, the manufacturing process can be simplified, and a manufacturing cost can be reduced, which makes it possible to enhance productivity.

According to the camera module of the invention, as the plurality of support portions formed in the housing are supported by the top and side surfaces of the image sensor mounted on the top surface of the PCB at three or more positions, the position of the housing having the lens assembly integrally provided thereon can be fixed to an accurate position, without being shifted, rotated, or tilted with respect to the image sensor.

Further, since the assembling process and the focus adjustment process for the camera module are simultaneously performed, the manufacturing process can be reduced, and the manufacturing cost can be reduced, which makes it possible to enhance productivity.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A camera module comprising:
a substrate;
an image sensor that is mounted on the substrate; and
a housing that is coupled to the top surface of the substrate and has a lens assembly integrally provided on the center thereof, the lens assembly having a plurality of lenses stacked therein, and a plurality of support portions which project from the side walls of the housing in the lower side of the lens assembly so as to be contact-supported by the top and side surfaces of the image sensor.

2. The camera module according to claim 1, wherein the support portions are contacted-supported by the top surface of the image sensor at three or more positions and contact-supported by the side surfaces of the images sensor at three or more positions.

3. The camera module according to claim 1, wherein the support portions include:
a first support portion which is contact-supported by a first side surface and the top surface of the image sensor;
a second support portion which is spaced at a predetermined distance from the first support portion so as to be contact-supported by the first side surface of the image sensor;
a third support portion which is contact-supported by the top surface of the image sensor so as to face the first support portion; and
a fourth support portion which is contact-supported by a second side surface and the top surface of the image sensor, the second side surface being adjacent to the first side surface.

4. The camera module according to claim 3, wherein the first side surface of the image sensor has a different length from the second side surface adjacent to the first side surface.

5. The camera module according to claim 4, wherein the length of the first side surface is larger than that of the second side surface.

6. The camera module according to claim 1, wherein the support portions are contact-supported by the outer region of the light receiving portion of the image sensor.
